(19) United States
(12) Patent Application Publication
(10) Pub. No.: US 2026/0150116 A1
(43) Pub. Date: May 28, 2026

(54) MULTI-SUB-CHANNEL SIDELINK RESOURCE SELECTION IN UNLICENSED SPECTRUM

(71) Applicant: Apple Inc., Cupertino, CA (US)

(72) Inventors: Chunhai Yao, Beijing (CN); Huaning Niu, San Jose, CA (US); Dawei Zhang, Saratoga, CA (US); Wei Zeng, Saratoga, CA (US); Haitong Sun, Saratoga, CA (US); Weidong Yang, San Diego, CA (US); Chunxuan Ye, San Diego, CA (US); Hong He, San Jose, CA (US); Sayed Ali Akbar Fakoorian, San Diego, CA (US)

(21) Appl. No.: 19/121,630

(22) PCT Filed: Nov. 4, 2022
(86) PCT No.: PCT/CN2022/130043

§ 371 Date: Apr. 16, 2025

(51) Int. Cl. H04W 72/40

(52) U.S. Cl. CPC H04W 72/40

(57) ABSTRACT

Systems, methods, and circuitries are provided for a UE performing sidelink (SL) communication in unlicensed spectrum to perform transmission resource selection. In one example, an apparatus for a user equipment (UE) operating in unlicensed spectrum is provided that includes one or more processors configured to cause the UE to receive configuration of pre-allocated resources in a plurality of sub-channels for sidelink (SL) communication; perform a clear sub-channel assessment (CCA) process in at least one of the plurality of sub-channels; determine a resource selection window comprising candidate resources in a subset of the pre-allocated resources; perform a resource selection process on the candidate resources in the resource selection window to determine transmission resources in at least two of the plurality of sub-channels; and based on results of the CCA process, transmit data using the transmission resources.

### BACKGROUND

Sidelink communication is performed between user equipments (UEs) with limited assistance from the network and forms the basis for vehicle to everything (V2X) communication systems. Sidelink communication is distinguished from downlink communication (network access point (AP) to a UE) and uplink communication (UE to AP).

One limiting factor in wireless innovation is the availability of spectrum. To mitigate this, the unlicensed spectrum has been an area of interest to expand the availability of Long Term Evolution (LTE) and New Radio (NR). In this context, recent releases of the 3GPP specification support LTE and NR uplink/downlink operation in the unlicensed spectrum.

### BRIEF DESCRIPTION OF THE DRAWINGS

Some examples of circuits, apparatuses and/or methods will be described in the following by way of example only. In this context, reference will be made to the accompanying figures.

FIG. 1 1 illustrates an overview of sidelink (SL) communication in unlicensed spectrum (SL-U) in a single sub-channel, in accordance with various aspects disclosed.

FIG. 2 illustrates an example timing for clear sub-channel assessment and transmission resource selection in SL-U in multiple sub-channels, in accordance with various aspects disclosed.

FIG. 3 illustrates an example timing for clear sub-channel assessment and transmission resource selection in SL-U in multiple sub-channels, in accordance with various aspects disclosed.

FIG. 4 illustrates an example timing for clear sub-channel assessment and transmission resource selection in SL-U in multiple sub-channels, in accordance with various aspects disclosed.

FIG. 5 illustrates an example timing for clear sub-channel assessment and transmission resource selection in SL-U in multiple sub-channels, in accordance with various aspects disclosed.

FIG. 6 illustrates an example timing for clear sub-channel assessment and transmission resource selection in SL-U in multiple sub-channels, in accordance with various aspects disclosed.

FIG. 7 illustrates an example timing for clear sub-channel assessment and transmission resource selection in SL-U in multiple sub-channels, in accordance with various aspects disclosed.

FIG. 8 is a flow diagrams outlining a method for a UE to perform clear sub-channel assessment and resource selection in SL-U in multiple sub-channels, in accordance with various aspects disclosed.

FIG. 9 illustrates an example of a UE, in accordance with various aspects disclosed.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Sidelink (SL) communication is continuing to be developed with many additional features being provided in certain releases of the 3GPP specification. As currently configured, sidelink communication does not include several features supported in UL/DL communication (i.e., communication between a UE and a base station over Uu link, for example).

Certain 3GPP releases support UL/DL communication in unlicensed spectrum (NR-U). In some instances, sidelink communication in unlicensed spectrum may also be supported. As with UL/DL, for sidelink communication in NR-U, devices may contend for access to the unlicensed frequency bands by performing clear sub-channel assessment (CCA) and Listen-Before-Talk (LBT) procedures prior to transmitting. There are two types of CCA procedures. In type 1 CCA, a random sensing period is used while in type 2 CCA, the sub-channel is sensed for a predefined time period. In one example, the sensing window for type 2 CCA is either 25 μs or 34 μs.

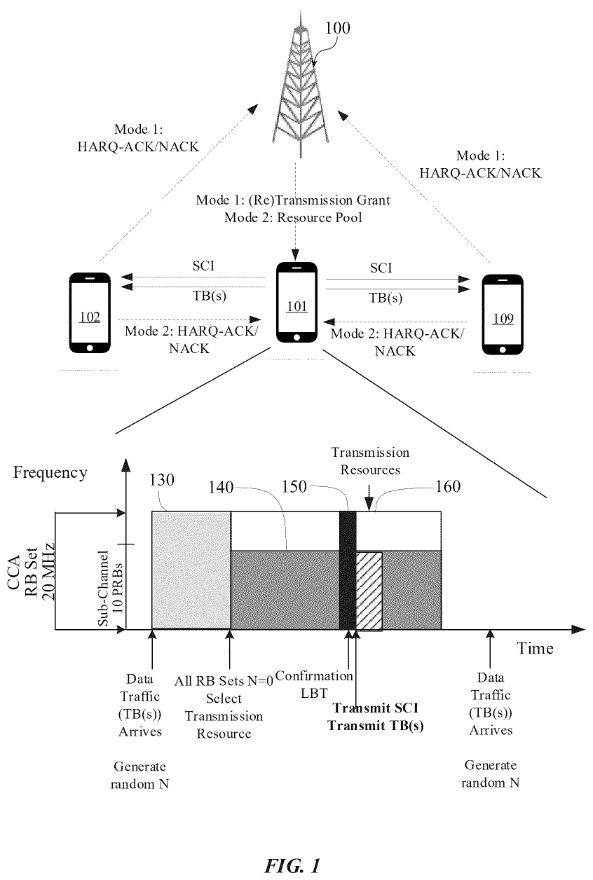

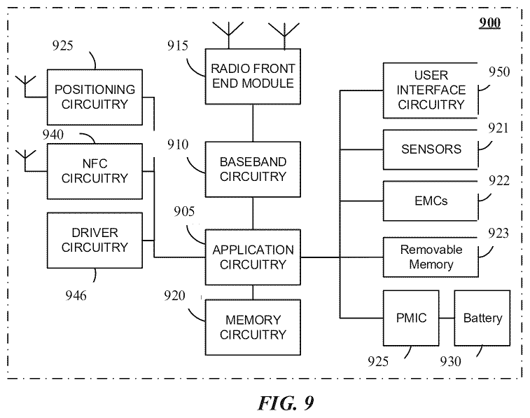

FIG. 1 is a block diagram of a wireless communication network in which UEs perform sidelink communication in a single pre-allocated sub-channel. Each UE in the network includes baseband circuitry that includes one or more processors configured to enable various types of sidelink communication. For the purposes of this description, when a “UE” or “device” is described as performing some function, it can be understood that it is the processor(s) in the baseband circuitry, in conjunction with stored instructions in a memory and/or transceivers(s) in some instances, that is performing the function. An example wireless communication device, including baseband circuitry, is illustrated in more detail in FIG. 9.

Sidelink communication may be performed according to one of two modes. In mode 1 the network controls resource allocation and receives feedback for transport blocks (TBs) transmitted between UEs (e.g., by way of signals transmitted or received by a base station or network node 100). In one example, resources for sidelink transmission are signaled to the transmitting UE as transmission grants. When the network determines, based on hybrid automatic repeat request (HARQ) acknowledgment/non-acknowledgement (ACK/NACK) signals received from the RX UEs, that a TB was not decoded by the receiving (RX) UE, the network transmits a retransmission grant to the transmitting (TX) UE indicating resources to be used to retransmit the TB.

In mode 2, the network preconfigures a pool of pre-allocated sidelink resources from which a TX UE selects transmission resources without requiring specific allocation from the network. In mode 2, feedback for TBs is provided to the TX UE by way of HARQ-ACK signals transmitted on a physical sidelink feedback sub-channel (PSFCH). SL resources may be allocated on a sub-channel basis. The frequency resources that make up a sub-channel may be configured as a certain number of physical resource blocks (PRBs). CCA may be performed on a per RB set basis (e.g., a 20 MHz bandwidth). Thus, SL resources may be allocated with a higher granularity than the CCA granularity. A SL resource pool may include multiple RB sets and sub-channels.

When the transmission is to occur in unlicensed spectrum, the TX UE first identifies that sub-channel(s) associated with resources allocated by the network (mode 1) or selected from the pre-allocated resource pool (mode 2) are clear prior to performing the sidelink transmission.

In the example of FIG. 1, sidelink resources are pre-allocated in a single sub-channel according to type 2. In the illustrated example, the pre-allocated pool of resources includes a sub-channel (e.g., 10 PRBs) spanning less than an RB set (e.g., 20 MHz). TX UE 101 seeks to transmit data (e.g., one or more TBs) to RX UEs 102 and 109. The timing of operations performed by the TX device to perform sidelink transmission in the single sub-channel are outlined in FIG. 1. When data traffic arrives for transmission by the TX UE (e.g., arrives in a transmit buffer), the UE performs type 1 CCAs in each RB set that overlaps the sub-channel prior to selecting transmission resources for the data. In FIG. 1, the CCA process occurs over a larger frequency range (e.g., 20 MHz) than the pre-allocated sub-channel (e.g., 10 PRBs). If the sub-channel overlapped two different RB sets, two different CCAs may be performed, one CCA for each RB set. When all CCAs on all RB sets overlapping the sub-channel complete successfully, the CCA process for the sub-channel is deemed successful.

For each CCA type 1 procedure performed by a TX device, an N counter for an RB set is initiated with a number N which is randomly generated as limited by a current contention window size CWS. During interval 130 (light gray shade) sub-channel sensing is performed on consecutive slot durations in the RB set and for each idle slot the N counter is decremented. When the N counter reaches zero, the counter is stopped or frozen and the type 1 CCA is deemed to be successful. If there were any other RB sets overlapping the sub-channel, CCA in those RB sets would also need to complete for the sub-channel to be clear.

The UE performs resource selection during a preconfigured resource selection window 140 (dark gray shade) to determine selected transmission resources 160 (hashed fill). The selected transmission resources may include candidate resources occurring at any time during the resource selection window 140. The selected transmission resources may be reserved so that other devices do not schedule over the selected transmission resources.

If a time interval between the end of the Type 1 CCA and the selected transmission resources is greater than a threshold, just prior to the transmission, the TX UE performs a confirmation LBT during the interval 150 (black shade). In one example the confirmation LBT is a type 2 CCA. If the confirmation LBT is successful, the TX UE 101 may send sidelink control information (SCI) using PSCCH resources associated with an LI destination ID for RX UEs 102 and 109. The SCI instructs the RX UEs 102, 109 how to subsequently receive one or more transport blocks (TBs) of data from TX UE 101. For example, the SCI identifies the selected transmission resources that will be used to transmit the TB(s). This indication may include an indication of time resources such as slot and/or symbol as well as frequency resources such as a sub-channel index and/or resource block (RB) set indexes. The TX UE then transmits the data (e.g., TB(s)) to RX UEs 102, 109. When new data traffic arrives, a new random value of N is generated for the subsequent Type 1 CCA.

While the example of FIG. 1 illustrates a type 1 CCA being used to determine that an RB set or sub-channel is clear, any type of CCA may be used in the techniques described herein.

Multi-sub-channel sidelink communication in unlicensed spectrum introduces challenges in determining appropriate sensing and resource selection procedures that balance performance, power consumption, and so on. Different methods for the TX device to select resources in sidelink mode 2 in an unlicensed, multi-sub-channel operating scenario are disclosed herein.

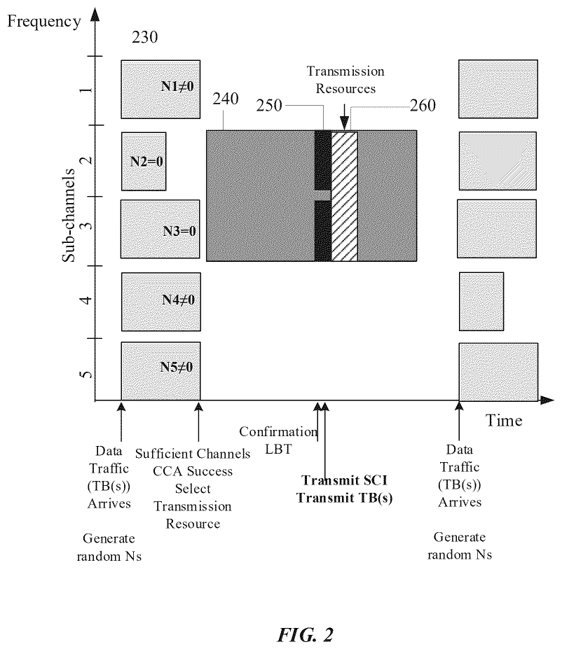

FIGS. 2-7 illustrate various techniques for performing mode 2 sidelink transmission in unlicensed spectrum using multiple sub-channels based on adaptations of the single sub-channel example of FIG. 1. In the illustrated examples, the CCA is a type 1 CCA, however any other type of CCA may be used. For the purposes of the examples in FIGS. 2-7, the pre-allocated resources include five different sub-channels (which may or may not be adjacent to one another) and the PSCCH/PSSCH transmission requires two sub-channels.

As described with reference to FIG. 1, a separate CCA may be performed on each RB set that overlaps a sub-channel and the overall CCA on the sub-channel may be considered successful when all CCAs are successful (e.g., all N counters=0). For the sake of simplicity, in FIGS. 2-7, there are five pre-allocated sub-channels that each span one entire RB set (e.g., 20 MHz per RB set or 100 MHz total pre-allocation) so that only one CCA per sub-channel is performed. One or multiple sub-channels can be used for sidelink transmission. It is to be understood that when sub-channels span more than one RB set, a CCA would be performed in each of the RB sets prior to the CCA being deemed successful. This performing of potentially multiple parallel CCAs in al RB sets that overlap a sub-channel may be referred to herein as a “CCA process” for the sub-channel. In one example, transmission resources must include adjacent RB sets and in another example the transmission resources may include non-adjacent RB sets.

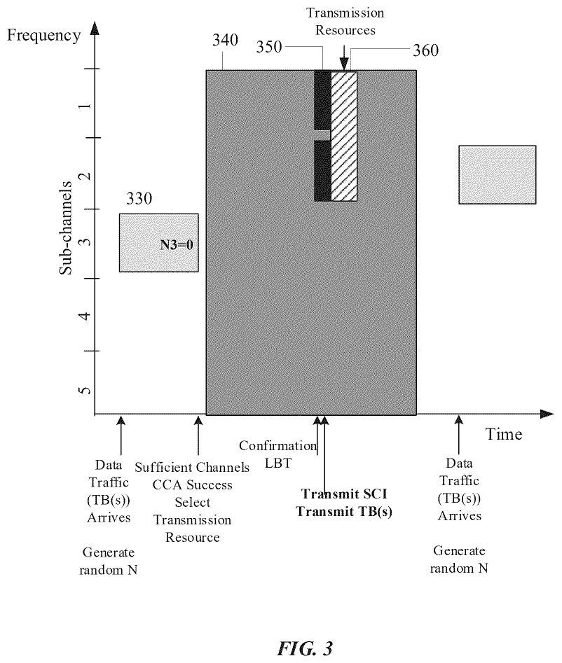

In a first set of techniques illustrated in FIGS. 2 and 3, CCA is performed in at least one of the pre-allocated sub-channels prior to performing transmission resource selection. In the example of FIG. 2, in response to data traffic arriving at the UE, CCA is performed in all of the sub-channels during the light gray shaded intervals 230 based on randomly generated N counter values for the sub-channels. Candidate resources in a first sub-channel to complete the CCA (sub-channel 2 in FIG. 2) and a second sub-channel to complete the CCA (sub-channel 3 in FIG. 2) are selected for a resource selection window 240. In some examples, the first sub-channel and the second sub-channel used for the resource selection window do not need to be adjacent to one another. In some examples, the first sub-channel and the second sub-channel must be adjacent to one another and in this case the first adjacent sub-channel to complete the CCA is selected as the second sub-channel for the resource selection window.

A resource selection process is performed on the candidate resources in the resource selection window to determine transmission resources 260. Once the transmission resources are determined, the transmission resources may be reserved.

If a sufficient amount of time elapses between an end of the CCA process on either sub-channel and the transmission resources, a confirmation LBT 250 (e.g., a type 2 CCA) may be performed in the first sub-channel and/or the second sub-channel. If the confirmation LBT 250 is successful, the TX UE transmits the PSCCH, the PSSCH, or both, using the transmission resources 260.

When new data traffic arrives at the UE buffer for transmission, a new random value of N is generated for the first sub-channel and the second sub-channel. In one example, all the N counters are reset and a new random value of N is generated for all the sub-channels in the pre-allocated resources while in another example the N counters in the other sub-channels are not reset and the counters continue to run in the subsequent CCA.

In the example of FIG. 3, in response to data traffic arriving at the UE, CCA is performed in a randomly selected sub-channel (sub-channel 3 in FIG. 3) during the light gray shaded interval 330 based on a randomly generated N counter value for the sub-channel. Once the CCA in the selected sub-channel completes, transmission resources 360 in a first sub-channel (sub-channel 1 in FIG. 3) and a second sub-channel (sub-channel 2 in FIG. 3) are selected from a resource selection window 340 that includes candidate resources in all five sub-channels. In some examples, the first sub-channel and the second sub-channel for the transmission resources do not need to be adjacent to one another. In some examples, the first sub-channel and the second sub-channel must be adjacent to one another. In one example (not shown), either the first sub-channel or the second sub-channel is the sub-channel in which the CCA was performed (sub-channel 3 in FIG. 2). Once the transmission resources are determined, the transmission resources may be reserved.

If a sufficient amount of time elapses between an end of the CCA process on either sub-channel and the transmission resources, a confirmation LBT 350 (e.g., a type 2 CCA) may be performed in the first sub-channel and/or the second sub-channel. If the confirmation LBT 350 is successful, the TX UE transmits the PSCCH (optional) and the PSSCH using the transmission resources 360. When new data traffic arrives, a new random value of N is generated for the sub-channel in which CCA was performed.

For the example techniques illustrated in FIGS. 2 and 3, a layer 1 (L1) LBT failure indication may be triggered when any of the CCAs (e.g., type 1 CCA) or the confirmation LBTs (e.g., type 2 CCA) on any RB set in a selected sub-channel is not successful before the selected transmission resources. The L1 LBT failure indication may be provided for only sub-channels overlapping the RB set in which the CCA or LBT failed or the L1 LBT failure indication may be provided for all selected sub-channels or all pre-allocated sub-channels. Since there is a relatively low chance of CCA failure when the transmission resources are selected after completing CCA, an LBT failure timer/threshold used to trigger selection of new pre-allocated SL resources may be set to a relatively small value.

For PSFCH transmission, a UE may transmit PSFCH to different UEs in different RB sets. In one option, PSFCH transmissions may follow a similar rule as PSSCH and PSCCH, where PSFCH transmission within one slot will be canceled if any of the RB sets fail CCA. In this case, an L1 LBT failure indication can be triggered as with PSSCH or PSCCH. In another option, PSFCH transmission may proceed in the RB sets where CCA is successful, whilst the PSFCH transmission is canceled in the RB sets where CCA is not successful. In this case, an L1 LBT failure indication can be triggered if any RB set does not clear CCA.

When mode 1 SL transmission is used, a layer 1 (L1) LBT failure indication may be triggered when any of the CCAs (e.g., type 1 CCA) or the confirmation LBTs (e.g., type 2 CCA) on any RB set is not successful before the selected transmission resources.

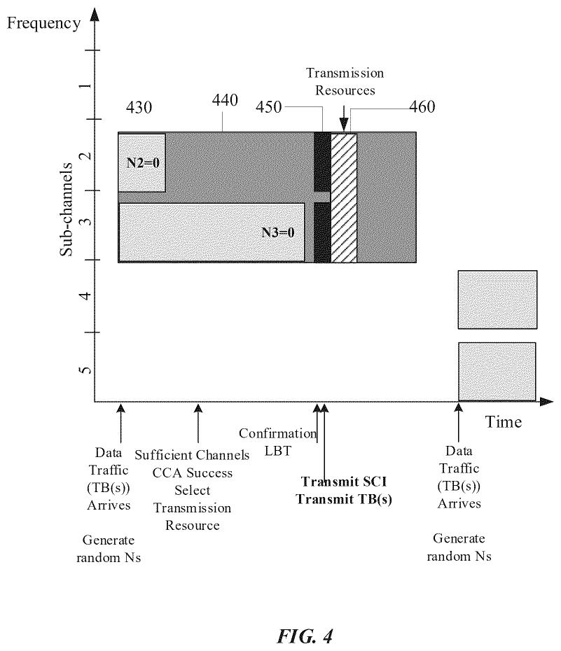

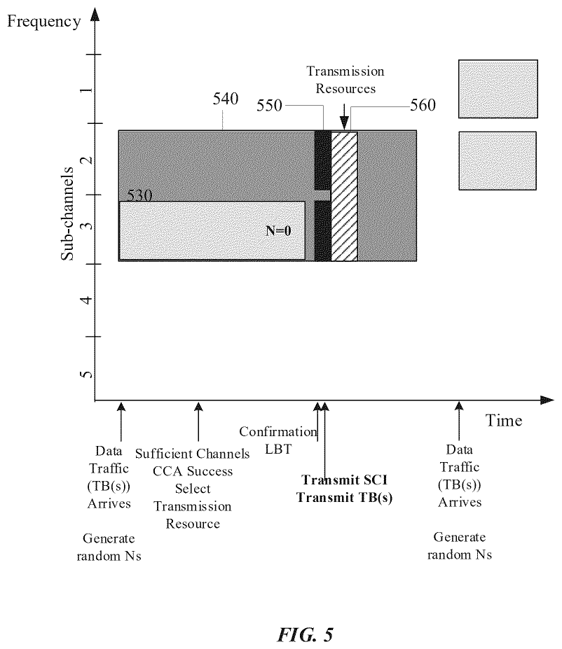

In a second set of example techniques illustrated in FIGS. 4 and 5, resource selection of candidate resources in selected sub-channels (e.g., two sub-channels in the examples) is performed prior to performing CCA on at least one of the selected sub-channels. In the example of FIG. 4, a resource selection window 440 including two sub-channels (sub-channels 2 and 3 in FIG. 4) is randomly selected. In one example the first and second sub-channels must be adjacent to one another. In one example the first and second sub-channels do not need to be adjacent to one another. Transmission resources 460 are selected using a resource selection process on the resource selection window 440. Once the transmission resources are determined, the transmission resources may be reserved.

The CCA processes 430 are begun in the selected first and second sub-channels after the transmission resources 460 are selected. If any of the CCA processes do not complete (N=0) sufficiently prior to the transmission resources, the PSSCH is dropped and a layer 1 (L1) LBT failure indication to the media access control (MAC) layer may be triggered.

If a sufficient amount of time elapses between an end of the CCA process and the transmission resources on either sub-channel, a confirmation LBT 450 (e.g., a type 2 CCA) may be performed in the first sub-channel and/or the second sub-channel. If the confirmation LBT 450 is successful, the TX UE transmits the PSCCH (optional) and the PSSCH using the transmission resources 460. When new data traffic arrives, a new random value of N is generated for the sub-channels in which CCA was performed.

In the example of FIG. 5, a resource selection window 540 including two sub-channels (sub-channels 2 and 3 in FIG. 4) is randomly selected. In one example the first and second sub-channels must be adjacent to one another. In one example the first and second sub-channels do not need to be adjacent to one another. Transmission resources 560 are selected using a resource selection process on the resource selection window 540. Once the transmission resources are determined, the transmission resources may be reserved.

The CCA process 530 is begun in a selected one of the first and second sub-channels (sub-channel 3 in FIG. 5) after the transmission resources 560 are selected. If f the CCA process does not complete (N=0) sufficiently prior to the transmission resources, the PSSCH is dropped and a layer 1 (L1) LBT failure indication to the media access control (MAC) layer is triggered.

If a sufficient amount of time elapses between an end of the CCA process and the transmission resources, a confirmation LBT 550 (e.g., a type 2 CCA) may be performed in the first sub-channel and/or the second sub-channel. If the confirmation LBT 550 is successful, the TX UE transmits the PSCCH (optional) and the PSSCH using the transmission resources 560. When new data traffic arrives, a new random value of N is generated for the sub-channel in which CCA was performed.

For the example techniques illustrated in FIGS. 4 and 5, a layer 1 (L1) LBT failure indication may be triggered when any of the CCAs (e.g., type 1 CCA) or the confirmation LBTs (e.g., type 2 CCA) on any RB set in a selected sub-channel is not successful before the selected transmission resources. Since there is a relatively high chance of CCA failure when the transmission resources are selected prior to completing CCA, an LBT failure timer/threshold used to trigger selection of new pre-allocated SL resources may be set to a relatively large value to avoid frequent LBT failure recovery procedures.

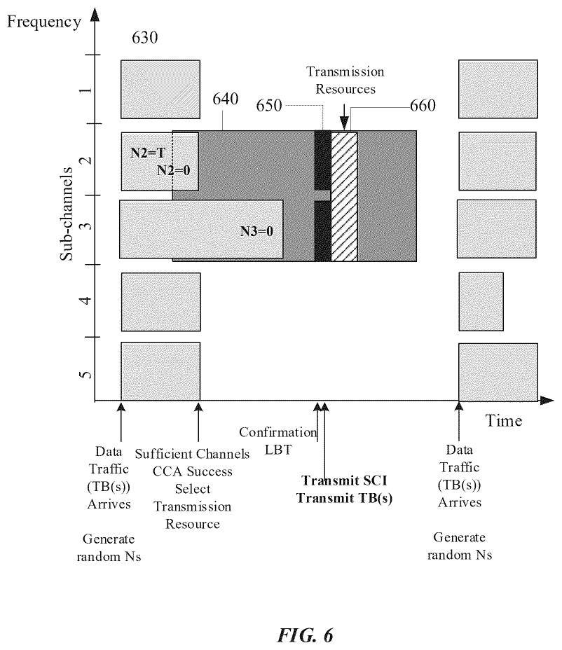

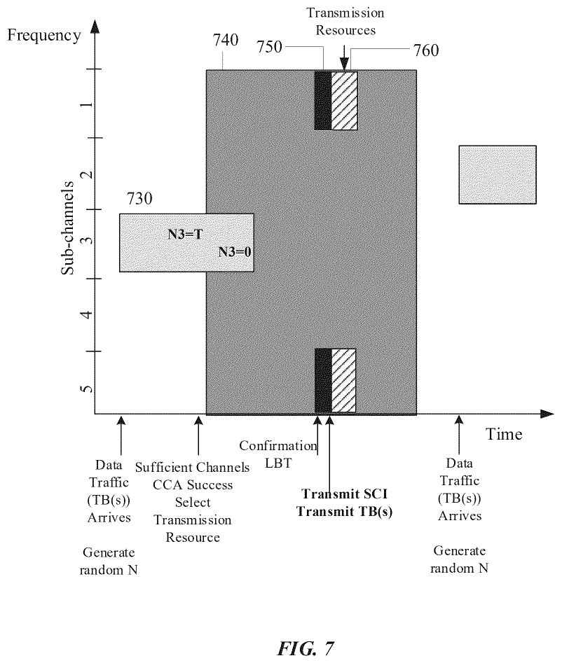

In a third set of techniques illustrated in FIGS. 6 and 7, CCA is performed in at least one of the pre-allocated sub-channels and when at least one of the CCAs reaches a threshold level of completion or progress (e.g., the N counter reaches a threshold number of percentage of its initial value “T”), transmission resources are selected. In the example of FIG. 6, in response to data traffic arriving at the UE, CCA is performed in all of the sub-channels during the light gray shaded intervals 630 based on randomly generated N counter values for each of the sub-channels. Candidate resources in a first sub-channel in which the CCA reaches the threshold level of completion (sub-channel 2 in FIG. 6) and a second randomly selected sub-channel (sub-channel 3 in FIG. 6) are selected for a resource selection window 640. In some examples, the first sub-channel and the second sub-channel used for the resource selection window do not need to be adjacent to one another. In some examples, the first sub-channel and the second sub-channel must be adjacent to one another.

While the CCA processes in the first sub-channel and the second sub-channel are progressing, a resource selection process is performed on the candidate resources in the resource selection window to determine transmission resources 660. Once the transmission resources are determined, the transmission resources may be reserved. Once the transmission resources are determined, the transmission resources may be reserved. If any of the CCA processes do not complete (N=0) sufficiently prior to the transmission resources, the PSSCH is dropped and a layer 1 (L1) LBT failure indication to the media access control (MAC) layer is triggered.

If a sufficient amount of time elapses between an end of the CCA process on either sub-channel and the transmission resources, a confirmation LBT 650 (e.g., a type 2 CCA) may be performed in the first sub-channel and/or the second sub-channel. If the confirmation LBT 650 is successful, the TX UE transmits the PSCCH (optional) and the PSSCH using the transmission resources 660.

When new data traffic arrives, a new random value of N is generated for the first sub-channel and the second sub-channel. In one example, the N counters are reset and a new random value of N is generated for all the sub-channels in the pre-allocated resources while in another example the N counters in the other sub-channels are not reset and the counters continue to run in the subsequent CCA.

In the example of FIG. 7, in response to data traffic arriving at the UE, CCA is performed in a randomly selected sub-channel (sub-channel 3 in FIG. 3) during the light gray shaded interval 730 based on a randomly generated N counter value for the sub-channel. Once the CCA in the selected sub-channel reaches the threshold level of completion, transmission resources 760 in a first sub-channel (sub-channel 1 in FIG. 3) and a second sub-channel (sub-channel 5 in FIG. 3) are selected from a resource selection window 740 that includes candidate resources in all five sub-channels. In some examples, the first sub-channel and the second sub-channel for the transmission resources do not need to be adjacent to one another. In some examples, the first sub-channel and the second sub-channel must be adjacent to one another. In one example (not shown), either the first sub-channel or the second sub-channel is the sub-channel in which the CCA was performed (sub-channel 3 in FIG. 2). Once the transmission resources are determined, the transmission resources may be reserved. If the CCA process does not complete (N=0) sufficiently prior to the transmission resources, the PSSCH is dropped and a layer 1 (L1) LBT failure indication to the media access control (MAC) layer is triggered.

If a sufficient amount of time elapses between an end of the CCA process on either sub-channel and the transmission resources, a confirmation LBT 750 (e.g., a type 2 CCA) may be performed in the first sub-channel and/or the second sub-channel. If the confirmation LBT 750 is successful, the TX UE transmits the PSCCH (optional) and the PSSCH using the transmission resources 760. When new data traffic arrives, a new random value of N is generated for the sub-channel in which CCA was performed.

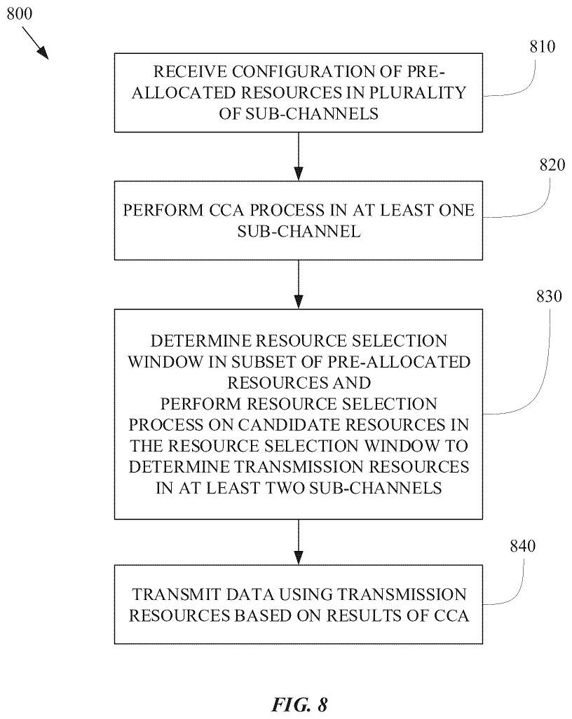

FIG. 8 is a flow diagram outlining an example method 800 that may be performed by a UE performing SL communication in unlicensed spectrum. The method includes, at 810, receiving configuration of pre-allocated resources in a plurality of sub-channels for sidelink (SL) communication. At 820, a clear sub-channel assessment (CCA) process is performed in at least one of the plurality of sub-channels. A resource selection window including candidate resources in a subset of the pre-allocated resources is determined and a resource selection process is performed on the candidate resources in the resource selection window to determine transmission resources in at least two of the plurality of sub-channels at 830. At 840, based on results of the CCA process, data is transmitted using the transmission resources.

In one example of method 800, the operations performed at 820 may be performed before the operations performed at 830 as disclosed with reference to FIGS. 2 and 3. In this example, the CCA process is performed in at least one of the plurality of pre-allocated sub-channels and then the resource selection window is determined and transmission resources are selected.

In one example of method 800, the operations performed at 830 may be performed before the operations performed at 820 as disclosed with reference to FIGS. 4 and 5. In this example, resource selection of candidate resources in selected sub-channels (e.g., two sub-channels in the examples) is performed prior to performing CCA on at least one of the selected sub-channels.

In one example of method 800, the operations performed at 820 may be performed while (e.g., at least partially overlapping with) the operations performed at 830 as disclosed with reference to FIGS. 6 and 7. In this example, CCA is performed in at least one of the pre-allocated sub-channels and when at least one of the CCAs reaches a threshold level of completion or progress (e.g., the N counter reaches a threshold number of percentage of its initial value “T”), transmission resources are selected.

It can be seen from the foregoing disclosure that many different techniques may be employed for performing sidelink transmission in unlicensed spectrum.

FIG. 9 illustrates an example of an apparatus 900 for a UE in accordance with various aspects. In aspects, the apparatus 900 may be suitable for use as UEs 101, 102, 109 of FIG. 1, and/or any other element/device discussed herein. The apparatus 900 may include any combinations of the components shown in the example. The components of apparatus 900 may be implemented as integrated circuits (ICs), portions thereof, discrete electronic devices, or other modules, logic, hardware, software, firmware, or a combination thereof adapted in the apparatus 900, or as components otherwise incorporated within a chassis of a larger system. The block diagram of FIG. 9 is intended to show a high level view of components of the apparatus 900. However, some of the components shown may be omitted, additional components may be present, and different arrangement of the components shown may occur in other implementations.

Application circuitry 905 includes circuitry such as, but not limited to one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 905 may be coupled with or may include memory/storage elements and may be configured to execute instructions stored in the memory/storage to enable various applications or operating systems to run on the system 900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

As examples, the processor(s) of application circuitry 905 may include a general or special purpose processor, such as an A-series processor (e.g., the A13 Bionic), available from Apple® Inc., Cupertino, CA or any other such processor. The processors of the application circuitry 905 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 905 may be a part of a system on a chip (SoC) in which the application circuitry 905 and other components are formed into a single integrated circuit, or a single package.

The baseband circuitry or processor 910 may be implemented, for example, as a solder-down substrate including one or more integrated circuits, a single packaged integrated circuit soldered to a main circuit board or a multi-chip module containing two or more integrated circuits. The memory circuitry 920 may store executable instructions that, when executed by the baseband processors, cause the UE or perform CCA or LBT in unlicensed spectrum, to select multi-sub-channel transmission resources, and based on the CCA or LBT, transmit data to one or more other UEs using SL communication protocols (e.g., unicast, groupcast, broadcast) over multiple sub-channels.

The apparatus 900 may also include interface circuitry (not shown) that is used to connect external devices with the apparatus 900. The external devices connected to the apparatus 900 via the interface circuitry include sensor circuitry 921 and electro-mechanical components (EMCs) 922, as well as removable memory devices coupled to removable memory circuitry 923. A battery 930 may power the apparatus 900, although in some examples the apparatus 900 may be mounted deployed in a fixed location, and may have a power supply coupled to an electrical grid.

In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

### EXAMPLES

Example 1 is an apparatus for a user equipment (UE) operating in unlicensed spectrum, including one or more processors configured to cause the UE to receive configuration of pre-allocated resources in a plurality of sub-channels for sidelink (SL) communication; perform a clear sub-channel assessment (CCA) process in at least one of the plurality of sub-channels; determine a resource selection window including candidate resources in a subset of the pre-allocated resources; perform a resource selection process on the candidate resources in the resource selection window to determine transmission resources in at least two of the plurality of sub-channels; and based on results of the CCA process, transmit data using the transmission resources.

Example 2 includes the subject matter of example 1, including or omitting optional elements, wherein the one or more processors are configured to perform the CCA process in at least one of the plurality of sub-channels prior to performing the resource selection process.

Example 3 includes the subject matter of example 1, including or omitting optional elements, wherein the one or more processors are configured to perform the resource selection process to select at least two sub-channels and then perform the CCA process on at least one of the selected at least two sub-channels.

Example 4 includes the subject matter of example 1, including or omitting optional elements, wherein the one or more processors are configured to begin the resource selection process during the performing of the CCA process on the one or more of the plurality of sub-channels.

Example 5 is an apparatus for a user equipment (UE) operating in unlicensed spectrum, including one or more processors configured to cause the UE to receive configuration of pre-allocated resources in a plurality of sub-channels for sidelink (SL) communication; perform a clear sub-channel assessment (CCA) process in at least one of the plurality of sub-channels; and after performing the CCA process, determine a resource selection window including candidate resources in a subset of the pre-allocated resources; and perform a resource selection process on the candidate resources in the resource selection window to determine transmission resources in at least two of the plurality of sub-channels; and based on results of the CCA process, transmit data using the transmission resources.

Example 6 includes the subject matter of example 5, including or omitting optional elements, wherein the one or more processors are configured to, in response to the data arriving for SL transmission, perform the CCA process in each of the plurality of sub-channels; select, for the resource selection window, candidate resources in a first sub-channel of the plurality of sub-channels in which a corresponding CCA process successfully completes; select, for the resource selection window, candidate resources in a second sub-channel of the plurality of sub-channels based on successful completion of a corresponding CCA process in the second sub-channel, wherein the resource selection window does not include candidate resources in other sub-channels of the plurality of sub-channels; and perform the resource selection process on the candidate resources in the resource selection window to determine the transmission resources.

Example 7 includes the subject matter of example 5, including or omitting optional elements, wherein the one or more processors are configured to, in response to the data arriving for SL transmission, perform the CCA process in a selected one of the plurality of sub-channels; in response to successful completion of the CCA process, select, for the resource selection window, candidate resources in all the plurality of sub-channels; and perform the resource selection process in the resource selection window to determine the transmission resources in a first sub-channel and a second sub-channel of the plurality of sub-channels.

Example 8 includes the subject matter of example 5, including or omitting optional elements, wherein the one or more processors are configured to select, as a first sub-channel or a second sub-channel of the transmission resources, the sub-channel in which the CCA is performed.

Example 9 is an apparatus for a user equipment (UE) operating in unlicensed spectrum, including one or more processors configured to cause the UE to receive configuration of pre-allocated resources in a plurality of sub-channels for sidelink (SL) communication; determine a resource selection window including candidate resources in a subset of the pre-allocated resources; and perform a resource selection process on the candidate resources in the resource selection window to determine transmission resources in at least two of the plurality of sub-channels; after determining the transmission resources, perform a clear sub-channel assessment (CCA) process in at least one of the plurality of sub-channels; and based on results of the CCA process, transmit data using the transmission resources.

Example 10 includes the subject matter of example 9, including or omitting optional elements, wherein the one or more processors are configured to, in response to the data arriving for SL transmission, select a resource selection window that includes candidate resources in a first sub-channel and a second sub-channel of the plurality of sub-channels; perform the resource selection process in the resource selection window to determine the transmission resources; perform the CCA process in the first sub-channel and the second sub-channel; and in response to successful completion of the CCA process in the first sub-channel and the second sub-channel prior to the transmission resources, transmit the data in the transmission resources.

Example 11 includes the subject matter of example 9, including or omitting optional elements, wherein the one or more processors are configured to, in response to the data arriving for SL transmission, select a resource selection window that includes candidate resources in a first sub-channel and a second sub-channel of the plurality of sub-channels; perform the resource selection process in the resource selection window to determine the transmission resources; begin the CCA process in a selected on of the first sub-channel and the second sub-channel; and in response to successful completion of the CCA process in the selected one of the first sub-channel and the second sub-channel prior to the transmission resources, transmit the data in the transmission resources.

Example 12 is an apparatus for a user equipment (UE) operating in unlicensed spectrum, including one or more processors configured to cause the UE to receive configuration of pre-allocated resources in a plurality of sub-channels for sidelink (SL) communication; perform a clear sub-channel assessment (CCA) process in at least one of the plurality of sub-channels; while performing the CCA process, determine a resource selection window including candidate resources in a subset of the pre-allocated resources; perform a resource selection process on the candidate resources in the resource selection window to determine transmission resources in at least two of the plurality of sub-channels; and based on results of the CCA process, transmit data using the transmission resources.

Example 13 includes the subject matter of example 12, including or omitting optional elements, wherein the one or more processors are configured to, in response to the data arriving for SL transmission, perform the CCA process in each of the plurality of sub-channels; select, for the resource selection window, candidate resources in a first sub-channel of the plurality of sub-channels in which a corresponding CCA reaches a threshold level of completion; select, for the resource selection window, candidate resources in a second sub-channel of the plurality of sub-channels, wherein the resource selection window does not include candidate resources in other sub-channels of the plurality of sub-channels; and perform the resource selection process on the candidate resources in the resource selection window to determine the transmission resources.

Example 14 includes the subject matter of example 12, including or omitting optional elements, wherein the one or more processors are configured to, in response to the data arriving for SL transmission, begin the CCA process in a selected one of the plurality of sub-channels; in response to the CCA process reaching a threshold level of completion, select, for the resource selection window, candidate resources in all the plurality of sub-channels; and perform the resource selection process in the resource selection window to determine the transmission resources in a first sub-channel and a second sub-channel of the plurality of sub-channels.

Example 15 includes the subject matter of example 14, including or omitting optional elements, wherein the one or more processors are configured to select, as the first sub-channel or the second sub-channel, the sub-channel in which the CCA is performed.

Example 16 includes the subject matter of any one of examples 1-15, including or omitting optional elements, wherein the one or more processors are configured to select, as the transmission resources, candidate resources in a first sub-channel and a second sub-channel, wherein the second sub-channel is adjacent the first sub-channel.

Example 17 includes the subject matter of any one of examples 1-15, including or omitting optional elements, wherein the one or more processors are configured to select, as the transmission resources, candidate resources in a first sub-channel and a second sub-channel, wherein the second sub-channel is either adjacent to or not adjacent to the first sub-channel.

Example 18 includes the subject matter of any one of examples 1-15, including or omitting optional elements, wherein the one or more processors are configured to determine a CCA process in a sub-channel to be successful when separate CCA processes in each resource block set of the sub-channel complete successfully.

Example 19 includes the subject matter of any one of examples 1-15, including or omitting optional elements, wherein the one or more processors are configured to select, for the transmission resources, adjacent resource block sets within each of the at least two of the plurality of sub-channels.

Example 20 includes the subject matter of any one of examples 1-15, including or omitting optional elements, wherein the one or more processors are configured to select, for the transmission resources, adjacent resource block sets or non-adjacent resource blocks within each of the at least two of the plurality of sub-channels.

Example 21 includes the subject matter of any one of examples 1-15, including or omitting optional elements, wherein the one or more processors are configured to, in response to an arrival of new data traffic for SL transmission, reset an N counter associated with the CCA processes corresponding to sub-channels selected for the transmission resources.

Example 22 includes the subject matter of any one of examples 1-15, including or omitting optional elements, wherein the one or more processors are configured to, in response to an arrival of new data traffic for SL transmission, reset an N counter associated with the CCA processes corresponding to all of the plurality of sub-channels.

Example 23 includes the subject matter of any one of examples 1-15, including or omitting optional elements, wherein the one or more processors are configured to, in response to an arrival of new data traffic for SL transmission, generate a new random value for N and reset an N counter associated with the CCA processes corresponding to sub-channels selected for the transmission resources.

Example 24 includes the subject matter of any one of examples 1-15, including or omitting optional elements, wherein the one or more processors are configured to, in response to an arrival of new data traffic for SL transmission, generate a new random value for N and reset an N counter associated with the CCA processes corresponding to all of the plurality of sub-channels.

Example 25 includes the subject matter of any one of examples 1-15, including or omitting optional elements, wherein the one or more processors are configured to, prior to transmitting the data, perform a confirmation listen-before-talk (LBT) on frequency resources of the transmission resources.

Example 26 includes the subject matter of example 25, including or omitting optional elements, wherein the confirmation LBT includes a type 2 CCA.

Example 27 includes the subject matter of example 25, including or omitting optional elements, wherein the one or more processors are configured to trigger a layer-1 (L1) LBT failure indication when the confirmation LBT fails.

Example 28 includes the subject matter of any one of examples 1-15, including or omitting optional elements, wherein the one or more processors are configured to trigger an L1 LBT failure indication in response to failure of a CCA process on one sub-channel.

Example 29 includes the subject matter of any one of examples 1-15, including or omitting optional elements, wherein the one or more processors are configured to trigger an L1 LBT failure indication in all selected sub-channels in response to failure of a CCA process on one selected sub-channel.

Example 30 includes the subject matter of any one of examples 1-15, including or omitting optional elements, wherein the CCA process includes a type 1 CCA.

Example 31 includes the subject matter of any one of examples 1-15, including or omitting optional elements, wherein the one or more processors are configured to, when the transmission includes a physical sidelink feedback channel (PSFCH) in a first sub-channel and a second sub-channel and a CCA process in the first sub-channel fails while a CCA process the second sub-channel succeeds, cancel the PSFCH in the first sub-channel and transmit the PSFCH in the second sub-channel.

Example 32 includes the subject matter of any one of examples 1-15, including or omitting optional elements, wherein the one or more processors are configured to, when the transmission includes a physical sidelink feedback channel (PSFCH) in a first sub-channel and a second sub-channel and a CCA process in the first sub-channel fails while a CCA process the second sub-channel succeeds, cancel the PSFCH in the first sub-channel and cancel the PSFCH in the second sub-channel.

Example 33 is an apparatus for a user equipment (UE) operating in unlicensed spectrum, including one or more processors configured to cause the UE to, in response to data arriving for SL transmission to another UE, receive an allocation of sidelink (SL) resources, wherein the allocated SL resources include candidate resources in a plurality of sub-channels; perform at least one clear sub-channel assessment (CCA) process in at least one of the plurality of sub-channels; and perform a resource selection process based on candidate resources in a resource selection window corresponding to at least a subset of the allocated SL resources to determine transmission resources that include frequency resources in at least two of the plurality of sub-channels; and trigger an L1 LBT failure indication in response to a CCA process failing in at least one sub-channel.

Example 34 includes the subject matter of example 34, including or omitting optional elements, wherein the at least one CCA process includes a type 1 CCA, a type 2 CCA, or both a type 1 CCA and a type 2 CCA.

Example 35 is a user equipment (UE) configured to operate in unlicensed spectrum, including a memory; and one or more processors configured to, when executing instructions stored in the memory, cause the UE to receive configuration of pre-allocated resources in a plurality of sub-channels for sidelink (SL) communication; perform a clear sub-channel assessment (CCA) process in at least one of the plurality of sub-channels; and after performing the CCA process, determine a resource selection window including candidate resources in a subset of the pre-allocated resources; and perform a resource selection process on the candidate resources in the resource selection window to determine transmission resources in at least two of the plurality of sub-channels; and based on results of the CCA process, transmit data using the transmission resources.

Example 36 includes the subject matter of example 35, including or omitting optional elements, wherein the one or more processors are configured to cause the UE to, in response to the data arriving for SL transmission, perform the CCA process in each of the plurality of sub-channels; select, for the resource selection window, candidate resources in a first sub-channel of the plurality of sub-channels in which a corresponding CCA process successfully completes; select, for the resource selection window, candidate resources in a second sub-channel of the plurality of sub-channels based on successful completion of a corresponding CCA process in the second sub-channel, wherein the resource selection window does not include candidate resources in other sub-channels of the plurality of sub-channels; and perform the resource selection process on the candidate resources in the resource selection window to determine the transmission resources.

Example 37 includes the subject matter of example 35, including or omitting optional elements, wherein the one or more processors are configured to cause the UE to, in response to the data arriving for SL transmission, perform the CCA process in a selected one of the plurality of sub-channels; in response to successful completion of the CCA process, select, for the resource selection window, candidate resources in all the plurality of sub-channels; and perform the resource selection process in the resource selection window to determine the transmission resources in a first sub-channel and a second sub-channel of the plurality of sub-channels.

Example 86 includes the subject matter of example 35, including or omitting optional elements, wherein the one or more processors are configured to cause the UE to select, as a first sub-channel or a second sub-channel of the transmission resources, the sub-channel in which the CCA is performed.

Example 39 is a method for a user equipment (UE) operating in unlicensed spectrum, including receiving configuration of pre-allocated resources in a plurality of sub-channels for sidelink (SL) communication; determining a resource selection window including candidate resources in a subset of the pre-allocated resources; and performing a resource selection process on the candidate resources in the resource selection window to determine transmission resources in at least two of the plurality of sub-channels; after determining the transmission resources, performing a clear sub-channel assessment (CCA) process in at least one of the plurality of sub-channels; and based on results of the CCA process, transmitting data using the transmission resources.

Example 40 includes the subject matter of example 39, including or omitting optional elements, including, in response to the data arriving for SL transmission, selecting a resource selection window that includes candidate resources in a first sub-channel and a second sub-channel of the plurality of sub-channels; performing the resource selection process in the resource selection window to determine the transmission resources; performing the CCA process in the first sub-channel and the second sub-channel; and in response to successful completion of the CCA process in the first sub-channel and the second sub-channel prior to the transmission resources, transmitting the data in the transmission resources.

Example 41 includes the subject matter of example 39, including or omitting optional elements, including, in response to the data arriving for SL transmission, selecting a resource selection window that includes candidate resources in a first sub-channel and a second sub-channel of the plurality of sub-channels; performing the resource selection process in the resource selection window to determine the transmission resources; beginning the CCA process in a selected on of the first sub-channel and the second sub-channel; and in response to successful completion of the CCA process in the selected one of the first sub-channel and the second sub-channel prior to the transmission resources, transmitting the data in the transmission resources.

Example 42 is an apparatus for a user equipment (UE) operating in unlicensed spectrum, including a memory; and one or more processors configured to, when executing instructions stored in the memory, cause the UE to receive configuration of pre-allocated resources in a plurality of sub-channels for sidelink (SL) communication; perform a clear sub-channel assessment (CCA) process in at least one of the plurality of sub-channels; while performing the CCA process, determine a resource selection window including candidate resources in a subset of the pre-allocated resources; perform a resource selection process on the candidate resources in the resource selection window to determine transmission resources in at least two of the plurality of sub-channels; and based on results of the CCA process, transmit data using the transmission resources.

Example 43 includes the subject matter of example 42, including or omitting optional elements, wherein the one or more processors are configured to, in response to the data arriving for SL transmission, cause the UE to perform the CCA process in each of the plurality of sub-channels; select, for the resource selection window, candidate resources in a first sub-channel of the plurality of sub-channels in which a corresponding CCA reaches a threshold level of completion; select, for the resource selection window, candidate resources in a second sub-channel of the plurality of sub-channels, wherein the resource selection window does not include candidate resources in other sub-channels of the plurality of sub-channels; and perform the resource selection process on the candidate resources in the resource selection window to determine the transmission resources.

Example 44 includes the subject matter of example 42, including or omitting optional elements, wherein the one or more processors are configured to, in response to the data arriving for SL transmission, cause the UE to begin the CCA process in a selected one of the plurality of sub-channels; in response to the CCA process reaching a threshold level of completion, select, for the resource selection window, candidate resources in all the plurality of sub-channels; and perform the resource selection process in the resource selection window to determine the transmission resources in a first sub-channel and a second sub-channel of the plurality of sub-channels.

Example 45 includes the subject matter of example 42, including or omitting optional elements, wherein the one or more processors are configured to cause the UE to select, as a first sub-channel or a second sub-channel, the sub-channel in which the CCA is performed.

Example 46 is a method that includes any action or combination of actions as substantially described herein in the Detailed Description.

Example 47 is a method as substantially described herein with reference to each or any combination of the Figures included herein or with reference to each or any combination of paragraphs in the Detailed Description.

Example 48 is a user equipment configured to perform any action or combination of actions as substantially described herein in the Detailed Description as included in the user equipment.

Example 49 is a network node configured to perform any action or combination of actions as substantially described herein in the Detailed Description as included in the network node.

Example 50 is a non-transitory computer-readable medium that stores instructions that, when executed, cause the performance of any action or combination of actions as substantially described herein in the Detailed Description.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A user equipment (UE) comprising
a radio front end module;
memory; and
one or more processors coupled to the memory and the radio front end module configured to, when executing instructions stored in the memory, cause the UE to:
receive, via the radio front end module, configuration of pre-allocated resources in a plurality of sub-channels for sidelink (SL) communication;
perform a clear sub-channel assessment (CCA) process in at least one of the plurality of sub-channels;
determine a resource selection window comprising candidate resources in a subset of the pre-allocated resources;
determine, from the candidate resources in the resource selection window, transmission resources in at least two of the plurality of sub-channels; and
based on results of the CCA process, transmit data using the transmission resources via the radio front end module.

2. The UE of claim 1, wherein the one or more processors are configured to perform the CCA process in at least one of the plurality of sub-channels prior to determining the transmission resources.

3. The UE of claim 1, wherein the one or more processors are configured to determine the transmission resources in the at least two sub-channels and then perform the CCA process on at least one of the selected at least two sub-channels.

4. The UE of claim 1, wherein the one or more processors are configured to begin determining the transmission resources during the performing of the CCA process on the one or more of the plurality of sub-channels.

5. The UE of claim 1, wherein the one or more processors are configured to select, as the transmission resources, candidate resources in a first sub-channel and a second sub-channel, wherein the second sub-channel is adjacent the first sub-channel.

6-9. (canceled)

10. The UE of claim 1, wherein the one or more processors are configured to, in response to an arrival of new data traffic for SL transmission, reset an N counter associated with the CCA processes corresponding to sub-channels selected for the transmission resources.

11. The UE of claim 1, wherein the one or more processors are configured to, in response to an arrival of new data traffic for SL transmission, reset an N counter associated with the CCA processes corresponding to all of the plurality of sub-channels.

12. The UE of claim 1, wherein the one or more processors are configured to, in response to an arrival of new data traffic for SL transmission, generate a new random value for N and reset an N counter associated with the CCA processes corresponding to sub-channels selected for the transmission resources.

13. The UE of claim 1, wherein the one or more processors are configured to, in response to an arrival of new data traffic for SL transmission, generate a new random value for N and reset an N counter associated with the CCA processes corresponding to all of the plurality of sub-channels.

14-18. (canceled)

19. The UE of claim 1, wherein the CCA process comprises a type 1 CCA.

20. The UE of claim 1, wherein the one or more processors are configured to, when the transmission comprises a physical sidelink feedback channel (PSFCH) in a first sub-channel and a second sub-channel and a CCA process in the first sub-channel fails while a CCA process the second sub-channel succeeds, cancel the PSFCH in the first sub-channel and transmit the PSFCH in the second sub-channel.

21. The UE of claim 1, wherein the one or more processors are configured to, when the transmission comprises a physical sidelink feedback channel (PSFCH) in a first sub-channel and a second sub-channel and a CCA process in the first sub-channel fails while a CCA process the second sub-channel succeeds, cancel the PSFCH in the first sub-channel and cancel the PSFCH in the second sub-channel.

22-25. (canceled)

26. A method for a user equipment (UE) operating in unlicensed spectrum, comprising:
receiving configuration of pre-allocated resources in a plurality of sub-channels for sidelink (SL) communication;
determining a resource selection window comprising candidate resources in a subset of the pre-allocated resources; and
determining, from the candidate resources in the resource selection window, transmission resources in at least two of the plurality of sub-channels;
after determining the transmission resources, performing a clear sub-channel assessment (CCA) process in at least one of the plurality of sub-channels; and
based on results of the CCA process, transmitting data using the transmission resources.

27. The method of claim 26, comprising, in response to the data arriving for SL transmission,
selecting a resource selection window that includes candidate resources in a first sub-channel and a second sub-channel of the plurality of sub-channels;
performing the CCA process in the first sub-channel and the second sub-channel; and in response to successful completion of the CCA process in the first sub-channel and the second sub-channel, transmitting the data in the transmission resources.

28. The method of claim 26, comprising, in response to the data arriving for SL transmission,
selecting a resource selection window that includes candidate resources in a first sub-channel and a second sub-channel of the plurality of sub-channels;
beginning the CCA process in a selected on of the first sub-channel and the second sub-channel; and
in response to successful completion of the CCA process in the selected one of the first sub-channel and the second sub-channel transmitting the data in the transmission resources.

29-34. (canceled)

35. The UE of claim 3, wherein the candidate resources are in a first sub-channel and a second sub-channel of the plurality of sub-channels, and wherein the one or more processors are configured to cause the UE to
perform the CCA process in the first sub-channel and the second sub-channel; and
in response to successful completion of the CCA process in the first sub-channel and the second sub-channel, transmit the data in the transmission resources.

36. The UE of claim 3, wherein the candidate resources are in a first sub-channel and a second sub-channel of the plurality of sub-channels, and wherein the one or more processors are configured to cause the UE to
determine the transmission resources in a first sub-channel and a second sub-channel of the plurality of sub-channels;
perform the CCA process in a selected one of the first sub-channel and the second sub-channel; and
in response to successful completion of the CCA process in the selected one of the first sub-channel and the second sub-channel, transmit the data in the transmission resources.

37. A baseband processor configured to, when executing instructions stored in a memory, perform operations, the operations comprising:
receiving configuration of pre-allocated resources in a plurality of sub-channels for sidelink (SL) communication;
determining a resource selection window comprising candidate resources in a subset of the pre-allocated resources; and
determine the candidate resources in the resource selection window to determine transmission resources in at least two of the plurality of sub-channels;
after determining the transmission resources, performing a clear sub-channel assessment (CCA) process in at least one of the plurality of sub-channels; and
based on results of the CCA process, causing transmission of data using the transmission resources.

38. The baseband processor of claim 37, wherein the candidate resources are in a first sub-channel and a second sub-channel of the plurality of sub-channels, and the operations comprise
performing the CCA process in the first sub-channel and the second sub-channel; and
in response to successful completion of the CCA process in the first sub-channel and the second sub-channel, causing transmission of the data in the transmission resources.

39. The baseband processor of claim 37, wherein the candidate resources are in a first sub-channel and a second sub-channel of the plurality of sub-channels, and the operations comprise
performing the CCA process in a selected one of the first sub-channel and the second sub-channel; and
in response to successful completion of the CCA process in the selected one of the first sub-channel and the second sub-channel, causing transmission of the data in the transmission resources.
